(19) United States
(12) Patent Application Publication
(10) Pub. No.: US 2025/0365239 A1
(43) Pub. Date: Nov. 27, 2025

(54) TRAFFIC CLASSIFICATION TO PORT MAPPING

(71) Applicant: QUALCOMM Incorporated, San Diego, CA (US)

(72) Inventors: Chaitanya PRATAPA, San Diego, CA (US); Vamsi DOKKU, San Diego, CA (US); Sitaramanjaneyulu KANAMARLAPUDI, San Diego, CA (US)

(21) Appl. No.: 18/674,799

(22) Filed: May 24, 2024

(51) Int. Cl. H04L 47/2441; H04W 28/02; H04W 76/15; H04W 88/06

(52) U.S. Cl. CPC H04L 47/2441; H04W 28/0263; H04W 76/15; H04W 88/06

(57) ABSTRACT

Methods, systems, and devices for wireless communications are described. A customer premises equipment (CPE) may communicate data traffic between a device of a first network and a second network according to a traffic classification and a set of Quality of Service (QoS) characteristics. For example, the CPE may establish a connection between the device of the first network and the second network. The CPE may map a traffic flow associated with the connection to a port within a port range the second network based on a traffic classification of the first network assigned to the traffic flow. The port range may be associated with a set of QoS characteristics of the second network. The CPE may communicate data traffic of the traffic flow between the device and the second network via the port in accordance with the traffic classification and the set of QoS characteristics.

### FIELD OF TECHNOLOGY

The present disclosure relates to wireless communications, including traffic classification to port mapping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, a customer premises equipment (CPE) may support traffic routing, such as between a local area network (LAN) and a cellular network. The LAN may be an example of a private network, and the cellular network may be an example of a public network.

### SUMMARY

The systems, methods, and devices of this disclosure each have several innovative aspects, no single one of which is solely responsible for the desirable attributes disclosed herein.

A method for wireless communications by a customer premises equipment (CPE) is described. The method may include communicating one or more messages to establish a connection between a first wireless communication device of a first network and a second network via the CPE, mapping a traffic flow associated with the connection to a first port within a first port range of a set of multiple port ranges of the second network based on a first traffic classification of a set of multiple traffic classifications of the first network assigned to the traffic flow, where the first port range is associated with a first set of Quality of Service (QoS) characteristics of a set of multiple sets of QoS characteristics of the second network, and where each port range of the set of multiple port ranges is associated with a different set of QoS characteristics of the set of multiple sets of QoS characteristics, and communicating, via the CPE, data traffic of the traffic flow between the first wireless communication device and the second network via the first port in accordance with the first traffic classification and the first set of QoS characteristics.

A CPE for wireless communications is described. The CPE may include one or more memories storing processor executable code, and one or more processors coupled with the one or more memories. The one or more processors may individually or collectively be operable to execute the code to cause the CPE to communicate one or more messages to establish a connection between a first wireless communication device of a first network and a second network via the CPE, map a traffic flow associated with the connection to a first port within a first port range of a set of multiple port ranges of the second network based on a first traffic classification of a set of multiple traffic classifications of the first network assigned to the traffic flow, where the first port range is associated with a first set of QoS characteristics of a set of multiple sets of QoS characteristics of the second network, and where each port range of the set of multiple port ranges is associated with a different set of QoS characteristics of the set of multiple sets of QoS characteristics, and communicate, via the CPE, data traffic of the traffic flow between the first wireless communication device and the second network via the first port in accordance with the first traffic classification and the first set of QoS characteristics.

Another CPE for wireless communications is described. The CPE may include means for communicating one or more messages to establish a connection between a first wireless communication device of a first network and a second network via the CPE, means for mapping a traffic flow associated with the connection to a first port within a first port range of a set of multiple port ranges of the second network based on a first traffic classification of a set of multiple traffic classifications of the first network assigned to the traffic flow, where the first port range is associated with a first set of QoS characteristics of a set of multiple sets of QoS characteristics of the second network, and where each port range of the set of multiple port ranges is associated with a different set of QoS characteristics of the set of multiple sets of QoS characteristics, and means for communicating, via the CPE, data traffic of the traffic flow between the first wireless communication device and the second network via the first port in accordance with the first traffic classification and the first set of QoS characteristics.

A non-transitory computer-readable medium storing code for wireless communications is described. The code may include instructions executable by one or more processors to communicate one or more messages to establish a connection between a first wireless communication device of a first network and a second network via the CPE, map a traffic flow associated with the connection to a first port within a first port range of a set of multiple port ranges of the second network based on a first traffic classification of a set of multiple traffic classifications of the first network assigned to the traffic flow, where the first port range is associated with a first set of QoS characteristics of a set of multiple sets of QoS characteristics of the second network, and where each port range of the set of multiple port ranges is associated with a different set of QoS characteristics of the set of multiple sets of QoS characteristics, and communicate, via the CPE, data traffic of the traffic flow between the first wireless communication device and the second network via the first port in accordance with the first traffic classification and the first set of QoS characteristics.

Some examples of the method, CPEs, and non-transitory computer-readable medium described herein may further include operations, features, means, or instructions for communicating one or more second messages to establish a second connection between a second wireless communication device of the first network and the second network and mapping a second traffic flow associated with the connection to a second port number within a second port range of the set of multiple port ranges of the second network based on a second traffic classification assigned to the traffic flow.

In some examples of the method, CPEs, and non-transitory computer-readable medium described herein, the second port range may be associated with a second set of QoS characteristics different from the first set of QoS characteristics.

Some examples of the method, CPEs, and non-transitory computer-readable medium described herein may further include operations, features, means, or instructions for reserving a set of multiple ports of the second network, where the traffic flow associated with the connection may be mapped to the first port within the first port range based on the set of multiple ports being reserved.

Some examples of the method, CPEs, and non-transitory computer-readable medium described herein may further include operations, features, means, or instructions for identifying the set of multiple port ranges based on the reserved set of multiple ports, where each port range of the set of multiple port ranges may be associated with a respective subset of the reserved set of multiple ports.

Some examples of the method, CPEs, and non-transitory computer-readable medium described herein may further include operations, features, means, or instructions for selecting the first port from the first port range based on the first traffic classification assigned to the traffic flow, where the traffic flow may be mapped to the first port based on selection of the first port.

In some examples of the method, CPEs, and non-transitory computer-readable medium described herein, the first network includes a local area network, and the second network includes a cellular network.

In some examples of the method, CPEs, and non-transitory computer-readable medium described herein, the first wireless communication device may be one of a set of multiple wireless communication devices of an automotive system.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support traffic classification to port mapping in accordance with one or more aspects of the present disclosure.

FIG. 3 shows an example of a process flow that supports traffic classification to port mapping in accordance with one or more aspects of the present disclosure.

FIGS. 4 and 5 show block diagrams of devices that support traffic classification to port mapping in accordance with one or more aspects of the present disclosure.

FIG. 6 shows a block diagram of a communications manager that supports traffic classification to port mapping in accordance with one or more aspects of the present disclosure.

FIG. 7 shows a diagram of a system including a device that supports traffic classification to port mapping in accordance with one or more aspects of the present disclosure.

FIGS. 8 and 9 show flowcharts illustrating methods that support traffic classification to port mapping in accordance with one or more aspects of the present disclosure.

### DETAILED DESCRIPTION

In some examples, a customer premises equipment (CPE) may include two parts: a private domain and a public domain. The private domain may include a private network, such as a local area network (LAN), and may support one or more configurable features, such as prioritization of users, prioritization of sub-networks, traffic shaping for devices, or the like. In other words, LANs may support an administration policy including classification levels and associated capabilities for different devices. The public domain may include a public network, such as a cellular network. In the public network, a protocol data unit (PDU) session may be associated with an internet protocol (IP) address, and different traffic flows may be associated with different port numbers. The public network may support Quality of Service (QoS) characteristics (e.g., parameters, requirements) via a traffic flow template (TFT). In some cases, a device may transition from the private domain to the public domain. The transition may involve a network address translation (NAT) in which port numbers are randomly selected by the CPE for each client of the private domain. However, the random selection may not support transfer of a policy configured by an administrator in the private network.

As described herein, a transition from a private domain to a public domain may be based on reserved ports sorted into groups, where each group is associated with QoS characteristics corresponding to a priority level in the private domain. For example, the CPE may sort reserved ports into respective port ranges. The CPE may map a traffic flow, based on a classification associated with the traffic flow, to a port range associated with a set of QoS characteristics. That is, different traffic classifications may be mapped to different port ranges associated with different QoS characteristics. By reserving port ranges and mapping the traffic flow to a port range according to a traffic classification of the traffic flow, the CPE may support coordination between the private domain and the public domain. For example, rather than randomly selecting a port for a traffic flow, techniques described herein support selection of a port based on traffic classifications, where the port is associated with QoS characteristics corresponding to a traffic classification. In other words, the CPE may support a transition of a device between the private domain and the public domain in accordance with traffic classifications of the private domain and associated QoS characteristics of the public domain.

Aspects of the disclosure are initially described in the context of wireless communications systems. Aspects of the disclosure are also described in the context of process flows. Aspects of the disclosure are further illustrated by and described with reference to apparatus diagrams, system diagrams, and flowcharts that relate to traffic classification to port mapping.

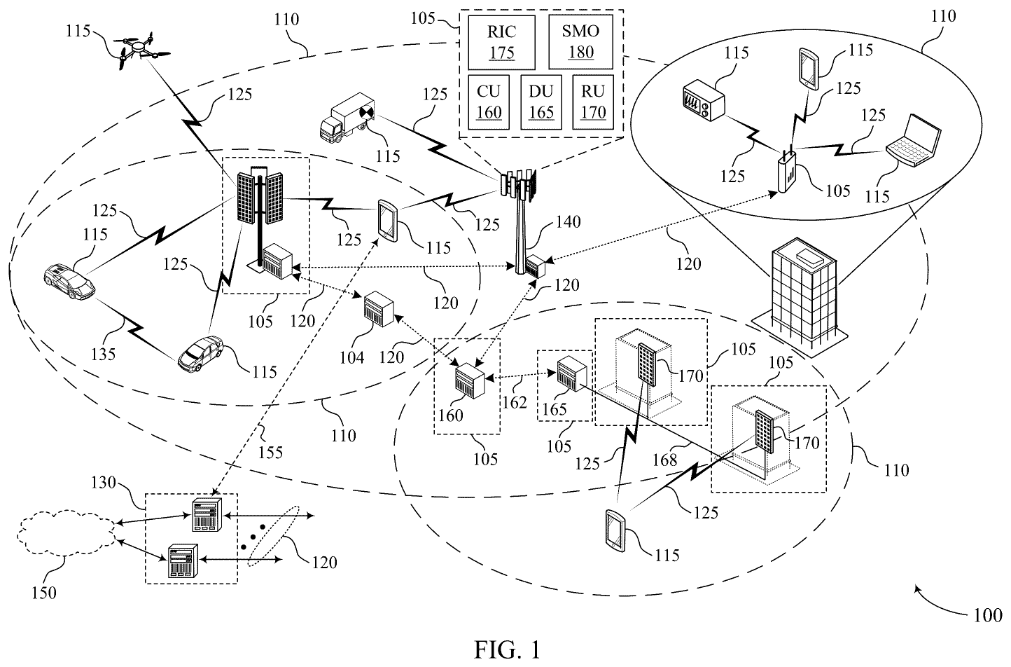

FIG. 1 shows an example of a wireless communications system 100 that supports traffic classification to port mapping in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As described herein, a CPE may support transitions between a first network and a second network according to an association between traffic classifiers of the first network and ranges of ports associated with QoS characteristics of the second network. For example, the CPE may reserve ranges of ports associated with different QoS characteristics, where the ranges of ports and different QoS characteristics correspond to different traffic classifiers. The CPE may establish a connection between the UE 115 of the first network, which may be an example of a LAN, and the second network (e.g., including the network entity 105), which may be an example of a cellular network. In examples in which the UE 115 transitions from the first network to the second network, the CPE may map a traffic flow of the connection to a port within a port range corresponding to a traffic classifier associated with the traffic flow, where the port range may be associated with a set of QoS characteristics. The CPE may communicate data traffic of the traffic flow between the UE 115 and the second network according to the set of QoS characteristics.

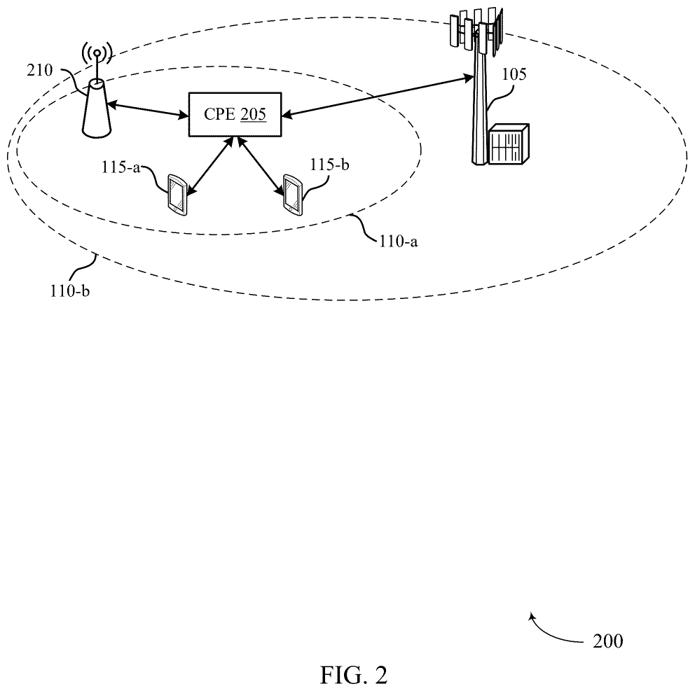

FIG. 2 shows an example of a wireless communication system 200 that supports traffic classification to port mapping in accordance with one or more aspects of the present disclosure. The wireless communication system 200 may implement or be implemented by various aspects of the wireless communications system 100. For example, the wireless communication system 200 may include a network entity 105, a UE 115-a, a UE 115-b, a coverage area 110-a, and a coverage area 110-b, which may be examples of the network entity 105, the UE 115, and the coverage area 110 as described with reference to FIG. 1.

The wireless communication system 200 may include or be an example of a CPE or fixed wireless access (FWA) environment. For example, the wireless communication system 200 may include a CPE 205. The CPE 205 may support end-to-end communication, such as communication between a private domain and a public domain. In some examples, the CPE 205 may include one or more first components associated with the private domain and one or more second components associated with the public domain. For example, CPE 205 may support communication with a LAN, such as a LAN including a Wi-Fi device 210 (e.g., an access point (AP), a station (STA), etc.) associated with a coverage area 110-a, and communication with a cellular network, such as a cellular network including the network entity 105 associated with a coverage area 110-b. As an example, the CPE 205 may communicate with the Wi-Fi device 210 via a fronthaul link, communicate with the network entity 105 via a backhaul link, or both.

In some examples, the private domain may be a part of or supported by (e.g., behind) the public domain. For example, the private domain may be connected to the public domain via the CPE 205. In other words, the private domain may be a component of or be supported by Wi-Fi, Ethernet, or both, where wireless communication devices of the private domain may be connected to a switch or router connected to the public domain via a modem (e.g., modem-based cellular communication). The private domain may operate according to a first communication protocol, such as a Wi-Fi or ethernet protocol, and the public domain may operate according to a second communication protocol, such as 3GPP™

The private domain (e.g., associated with a router, Wi-Fi, Ethernet, LAN, etc.) may use private addresses to identify different users. In other words, the private domain may use a private address space to identify different users in the private domain. In some examples, a router may manage the private network according to traffic classifications across users, different bandwidth and traffic policies associated with sub-networks of the private domain, differential or configurable features (e.g., prioritizing one or more users, prioritizing sub-networks, traffic shaping of devices, etc.). For example, the router may include or support an administration policy, which may include respective features or capabilities associated with different traffic classifications (e.g., classification levels). That is, the router may apply the administration policy, which may include applying features or capabilities based on a traffic classification of an address. As an example, the administration policy may include priorities associated with different users, sub-networks, traffic types, or the like of the private domain. For example, the administration policy may include a priority ranking of different users, sub-networks (e.g., areas of the private domain, areas within the coverage area 110-a, etc.), traffic types, or the like, where features or capabilities may be applied in accordance with the priority ranking.

The public domain (e.g., the cellular network) may use public addresses to identify users. For example, the public domain may use a public address-based mechanism to identify users, where users are assigned an IP address associated with a PDU session. Multiple traffic flows on the PDU session may be associated with a same IP address but different port numbers. That is, different traffic flows of the PDU session may be identified at a data protocol level. Additionally, or alternatively, the public domain may support QoS characteristics (e.g., requirements), such as according to QoS Flow Identifier (QFI)-based policies (e.g., or 5G-QoS Identifier (5QI) policies). For example, during establishment of a PDU session, the public domain may establish QoS characteristics for a traffic flow according to a traffic flow template (TFT) indicated via one or more signals (e.g., non-access stratum (NAS) signaling).

In some examples, UEs, such as the UE 115-a or the UE 115-b, (e.g., in a radio environment) may include a framework or configuration for satisfying the QoS characteristics (e.g., uplink and/or downlink QoS requirements). For example, the UEs may map traffic flows to radio bearers, logical channels, or both associated with priority levels (e.g., logical channel priority) capable of satisfying the QoS characteristics. In some examples, the UEs may map traffic flows in accordance with satisfying the QoS characteristics during MAC-based logical channel prioritization procedures while utilizing uplink grants provided by the network entity 105. Additionally, or alternatively, the network entity 105 may support a RAN-based QoS policy (e.g., configured by a user plane function (UPF)). For example, the network entity 105 may prioritize one or more traffic flows based on satisfying the QoS characteristics (e.g., meeting QoS requirements) in downlink traffic via traffic scheduling on one or more radio bearers with a traffic flow.

A wireless device, such as the UE 115-a or the UE 115-b may undergo traffic routing from the private domain to the public domain. Traffic routing from the private domain to the public domain may involve a NAT in which port numbers are selected by the CPE 205 for the UE 115-a, the UE 115-b, or both, and, in some examples, different traffic flows of the UE 115-a and the UE 115-b. For example, during the NAT, the CPE 205 may map cellular-based public addresses (e.g., IP addresses) with different ports to different private addresses of the private domain (e.g., a LAN). In other words, the CPE 205 may generate port-private address combinations for each traffic flow. In some cases, the CPE 205 may randomly select the port numbers for each client, flow, or both of the private domain during the NAT via a first packet directed toward the public domain. However, random selection of the port numbers may not support coordination between traffic classifications in the private domain and QoS characteristics in the public domain.

For example, during NAT, traffic classifications in the private domain change may not correspond to QoS characteristics in the public domain. In other words, with the NAT, as the address space of the private domain changes, a QoS configuration (e.g., a corresponding QoS configuration) may not be applied in the public domain (e.g., cellular network). In such examples, end-to-end traffic QoS characteristics may not be satisfied in an uplink direction (e.g., a QoS requirement may be broken). Accordingly, traffic classification-based differential traffic shaping or policing requirements may not be supported, such as may not be enabled, by mobile station modem (MSM)-based traffic routing. Additionally, support for coordination between traffic classifications and QoS characteristics may be applicable to examples in which the private domain is in a vehicle (e.g., in an auto domain), where the private domain may be connected to the public domain via a telematics module.

To support coordination between traffic classifications in the private domain and QoS characteristics in the public domain, the CPE 205 may reserve ports of the public domain. For example, the CPE 205 may reserve multiple ports of a cellular network associated with the network entity 105. In some examples, the CPE 205 may reserve the multiple ports via IP tables (e.g., via a Linux system using MASQUERADE-to-ports).

The CPE 205 may divide the reserved ports into groups. For example, the groups may accommodate classification across different clients of the private domain, such as across devices or traffic flows of a LAN. The groups may be ranges of port numbers. As an example, a first group may include a first range of port numbers (e.g., port numbers 1001-2000), a second group may include a second range of port numbers (e.g., port numbers 2001-3000), a third group may include a third range of port numbers (e.g., port numbers 3001-4000), and so on.

The CPE 205 may map traffic flows to ports. For example, the CPE 205 may map a first traffic flow of the UE 115-a of the LAN to a first port. In some examples, the CPE 205 may select the first port based on a traffic classification associated with the first traffic flow, where a traffic classification is one of multiple traffic classifications of the LAN. As an example, the traffic classification may be related to a priority level, features, or capabilities configurable at a policy of the LAN. In some examples, the CPE 205 may perform translation from the LAN to the cellular network according to a NAT policy (e.g., a static NAT policy) supporting traffic classifier-based port usage. For example, clients associated with a first traffic classifier may be mapped to a port number of the first group (e.g., first range of port numbers), clients associated with a second traffic classifier may be mapped to a port number of the second group (e.g., second range of port numbers), and so on.

The respective ranges of port numbers may follow different QoS characteristics. As an example, traffic flows mapped to port numbers of the first group may follow first QoS characteristics, traffic flows mapped to port numbers of the second group may follow second QoS characteristics, and so on. That is, the CPE 205 may communicate data traffic between the network entity 105 and the UE 115-a according to QoS characteristics associated with a port range of a port selected by the CPE 205 based on a traffic classification of the UE 115-a. For example, the CPE 205 may use the NAT policy supporting port-range based QoS usage.

As an example, the CPE 205 may map a high priority traffic flow of the UE 115-a to a first port of first port range associated with a first set of QoS characteristics. Additionally, the CPE 205 may map a low priority traffic flow of the UE 115-b to a second port of a second port range associated with a second set of QoS characteristics. In some examples, a priority of a traffic flow may be based on a traffic type of the traffic flow, a priority level of the associated UE, or both. For example, a policy of the private domain may identify one or more traffic types or UEs as being high priority or low priority. In the example of FIG. 2, the policy may identify the UE 115-a as a high priority UE relative to the UE 115-b. The first set of QoS characteristics may be associated with a higher performance level (e.g., high reliability, low delay, greater bandwidth) than the second set of QoS characteristics. That is, the respective sets of QoS characteristics may correspond to or be consistent with a priority level associated with the traffic flow. For example, the CPE 205 may support consistent end-to-end handling for the high priority traffic flow and the low-priority traffic flow across the private domain and the public domain.

By reserving port numbers of the public domain and associating ranges of port numbers with different traffic classifiers, the CPE 205 may support coordination between the private domain and the public domain. In other words, the CPE 205 may support translation of traffic classifiers to QoS characteristics during traffic routing from the LAN to the cellular network. The CPE 205 may, based on reserving the port numbers and associating ranges of port numbers with different traffic classifiers, ensure that end-to-end QoS characteristics are satisfied. In other words, the mapping may enable data traffic to receive consistent end-to-end handling, such as end-to-end QoS, across the private domain and the public domain. For example, the CPE 205 may, by mapping traffic flows to selected port ranges, enable a traffic flow to be associated with QoS characteristics in the public domain corresponding to a traffic classification in the private domain.

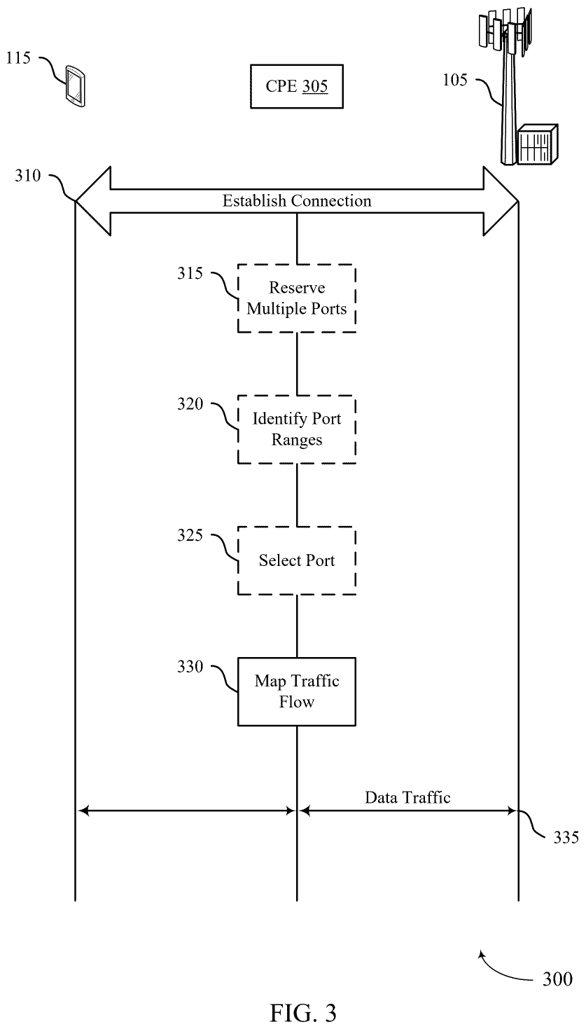

FIG. 3 shows an example of a process flow 300 that supports traffic classification to port mapping in accordance with one or more aspects of the present disclosure. In some examples, the process flow 300 may implement or be implemented by aspects of the wireless communications system 100, the wireless communication system 200, or both. For example, the process flow 300 may include a UE 115, a CPE 305, and a network entity 105, which may be examples of corresponding devices as illustrated by and described with reference to FIGS. 1 and 2.

Alternative examples of the following may be implemented. Some operations are performed in a different order than described or are not performed at all. In some cases, operations may include additional features not mentioned below, or further operations may be added. Although the UE 115, the CPE 305, and the network entity 105 are shown performing the operations of the process flow 300, some aspects of some operations may also be performed by one or more other wireless communication devices.

At 310, the CPE 305 may communicate one or more messages to establish a connection between the UE 115 and the network entity 105. For example, the UE 115 may be a device of one or more devices of a first network. As an example, the UE 115 may be one of multiple wireless communication devices of an automotive system. The network entity 105 may be an example of a device of one or more devices of a second network. In other words, the CPE 305 may establish a connection between devices of a first network with a second network. In some examples, the first network may be an example of a LAN, and the second network may be an example of a cellular network.

In some examples, the CPE 305 may establish more than one connection. For example, the CPE 305 may communicate one or more second messages to establish a second connection between a second wireless communication device (e.g., different than the UE 115) of the first network and the second network. As an example, the second wireless communication device may be one of the multiple wireless communication devices of the automotive system. In other words, the CPE 305 may establish connections between respective devices of multiple devices of the first network with a second network.

At 315, the CPE 305 may reserve multiple ports. For example, the CPE 305 may reserve multiple ports of the second network, such as the second network associated with the network entity 105. After reserving the multiple ports at 315, at 320, the CPE 305 may identify port ranges. For example, the CPE 305 may identify multiple port ranges based on the reserved multiple ports. Each port range may be associated with a respective subset of the reserved multiple ports. As an example, a first port range may correspond to a first subset of reserved ports, a second port range may correspond to a second subset of reserved ports, and so on. In some examples, the port ranges may be non-overlapping. That is, each port of the multiple reserved ports may be associated with a single port range. In some examples, different port ranges may be associated with different QoS characteristics. For example, each port range of the multiple port ranges may be associated with a different set of QoS characteristics of multiple sets of QoS characteristics of the second network.

At 325, the CPE 305 may select a port. For example, the CPE 305 may select a first port from a first port range based on a traffic classification assigned to a traffic flow of the connection, such as the connection established at 310. The CPE 305 may select ports for one or more devices of the first network having connections with the second network. That is, the CPE 305 may select a second port from a second port range based on a traffic classification assigned to a traffic flow of a connection between the second wireless communication device of the first network and the second network.

At 330, the CPE 305 may map the traffic flow. For example, the CPE 305 may map the traffic flow associated with the connection established at 310 to the first port selected at 325. That is, the CPE 305 may map the traffic flow to the first port of the first port range based on the traffic classification assigned to the traffic flow, based on the selection of the first port at 325, or both. In examples in which the first network includes more than one device having a connection with the second network, the CPE 305 may map traffic flows of respective devices to different ports of the second network. For example, the CPE 305 may map a traffic flow of the second wireless communication device to the second port from the second port range.

At 335, the CPE 305 may communicate data traffic. For example, the CPE 305 may communicate data traffic of the traffic flow between the UE 115 and the network entity 105 in accordance with the first traffic classification and the first set of QoS characteristics. In other words, the CPE 305 may communicate data traffic between devices of the first network and the second network according to the mapping at 330. For example, the data traffic between the devices of the first network and the second network may be associated with the QoS characteristics of a respective port range of a selected port for the different devices. That is, the CPE 305 may communicate the data traffic of devices according to QoS characteristics corresponding to traffic classifications of devices in the first network. In accordance with the port reservation at 315, the mapping at 330, or both, the CPE 305 may support coordination between the first network and the second network. For example, the CPE 305 may, based on reserving the port numbers at 315 and associating ranges of port numbers with different traffic classifiers, ensure that end-to-end QoS characteristics are satisfied for the traffic flow associated with the UE 115. In other words, the mapping may enable data traffic to receive consistent end-to-end handling, such as end-to-end QoS, across the first network and the second network.

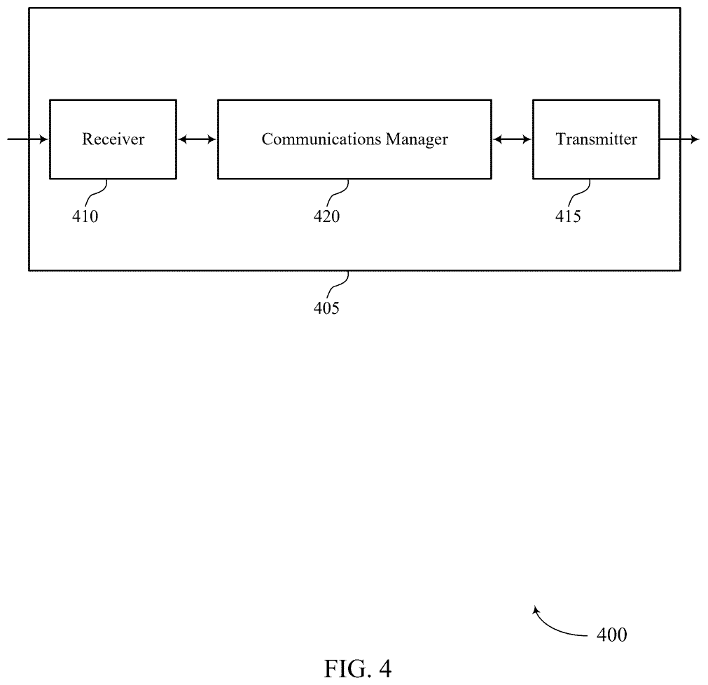

FIG. 4 shows a block diagram 400 of a device 405 that supports traffic classification to port mapping in accordance with one or more aspects of the present disclosure. The device 405 may be an example of aspects of a customer premises equipment as described herein. The device 405 may include a receiver 410, a transmitter 415, and a communications manager 420. The device 405 may also include one or more processors, memory coupled with the one or more processors, and instructions stored in the memory that are executable by the one or more processors to enable the one or more processors to perform the traffic classification to port mapping features discussed herein. Each of these components may be in communication with each other (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The transmitter 415 may provide a means for outputting (e.g., transmitting, providing, conveying, sending) information generated by other components of the device 405. For example, the transmitter 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 415 may support outputting information by transmitting signals via one or more antennas. Additionally, or alternatively, the transmitter 415 may support outputting information by transmitting signals via one or more wired (e.g., electrical, fiber optic) interfaces, wireless interfaces, or any combination thereof. In some examples, the transmitter 415 and the receiver 410 may be co-located in a transceiver, which may include or be coupled with a modem.

The communications manager 420, the receiver 410, the transmitter 415, or various combinations or components thereof may be examples of means for performing various aspects of traffic classification to port mapping as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for communicating one or more messages to establish a connection between a first wireless communication device of a first network and a second network via the CPE. The communications manager 420 is capable of, configured to, or operable to support a means for mapping a traffic flow associated with the connection to a first port within a first port range of a set of multiple port ranges of the second network based on a first traffic classification of a set of multiple traffic classifications of the first network assigned to the traffic flow, where the first port range is associated with a first set of Quality of Service (QoS) characteristics of a set of multiple sets of QoS characteristics of the second network, and where each port range of the set of multiple port ranges is associated with a different set of QoS characteristics of the set of multiple sets of QoS characteristics. The communications manager 420 is capable of, configured to, or operable to support a means for communicating, via the CPE, data traffic of the traffic flow between the first wireless communication device and the second network via the first port in accordance with the first traffic classification and the first set of QoS characteristics.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

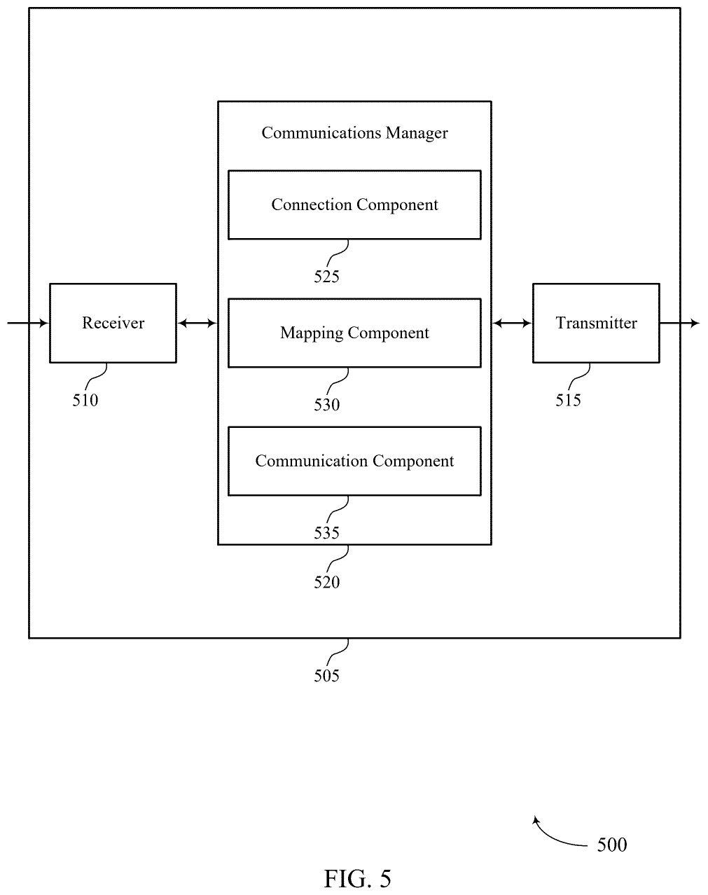

FIG. 5 shows a block diagram 500 of a device 505 that supports traffic classification to port mapping in accordance with one or more aspects of the present disclosure. The device 505 may be an example of aspects of a device 405 or a CPE 205 as described herein. The device 505 may include a receiver 510, a transmitter 515, and a communications manager 520. In some cases, the connection component 525, the mapping component 530, and the communication component 535 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the connection component 525, the mapping component 530, and the communication component 535 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The device 505, or various components thereof, may be an example of means for performing various aspects of traffic classification to port mapping as described herein. For example, the communications manager 520 may include a connection component 525, a mapping component 530, a communication component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The connection component 525 is capable of, configured to, or operable to support a means for communicating one or more messages to establish a connection between a first wireless communication device of a first network and a second network via the CPE. The mapping component 530 is capable of, configured to, or operable to support a means for mapping a traffic flow associated with the connection to a first port within a first port range of a set of multiple port ranges of the second network based on a first traffic classification of a set of multiple traffic classifications of the first network assigned to the traffic flow, where the first port range is associated with a first set of Quality of Service (QoS) characteristics of a set of multiple sets of QoS characteristics of the second network, and where each port range of the set of multiple port ranges is associated with a different set of QoS characteristics of the set of multiple sets of QoS characteristics. The communication component 535 is capable of, configured to, or operable to support a means for communicating, via the CPE, data traffic of the traffic flow between the first wireless communication device and the second network via the first port in accordance with the first traffic classification and the first set of QoS characteristics.

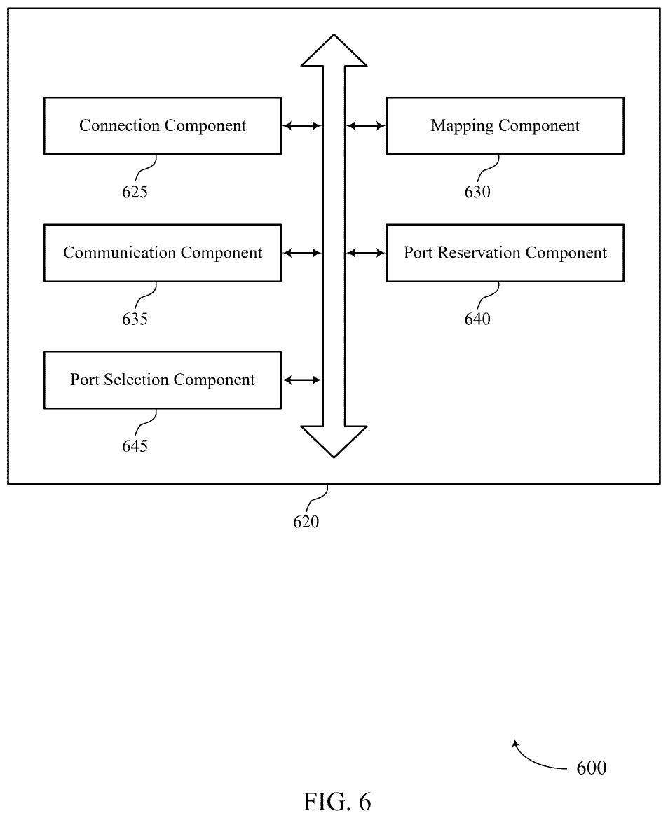

FIG. 6 shows a block diagram 600 of a communications manager 620 that supports traffic classification to port mapping in accordance with one or more aspects of the present disclosure. The communications manager 620 may be an example of aspects of a communications manager 420, a communications manager 520, or both, as described herein. The communications manager 620, or various components thereof, may be an example of means for performing various aspects of traffic classification to port mapping as described herein. For example, the communications manager 620 may include a connection component 625, a mapping component 630, a communication component 635, a port reservation component 640, a port selection component 645, or any combination thereof. In some cases, the connection component 625, the mapping component 630, the communication component 635, the port reservation component 640, the port selection component 645, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the connection component 625, the mapping component 630, the communication component 635, the port reservation component 640, the port selection component 645 discussed herein. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The connection component 625 is capable of, configured to, or operable to support a means for communicating one or more messages to establish a connection between a first wireless communication device of a first network and a second network via the CPE. The mapping component 630 is capable of, configured to, or operable to support a means for mapping a traffic flow associated with the connection to a first port within a first port range of a set of multiple port ranges of the second network based on a first traffic classification of a set of multiple traffic classifications of the first network assigned to the traffic flow, where the first port range is associated with a first set of Quality of Service (QoS) characteristics of a set of multiple sets of QoS characteristics of the second network, and where each port range of the set of multiple port ranges is associated with a different set of QoS characteristics of the set of multiple sets of QoS characteristics. The communication component 635 is capable of, configured to, or operable to support a means for communicating, via the CPE, data traffic of the traffic flow between the first wireless communication device and the second network via the first port in accordance with the first traffic classification and the first set of QoS characteristics.

In some examples, the connection component 625 is capable of, configured to, or operable to support a means for communicating one or more second messages to establish a second connection between a second wireless communication device of the first network and the second network. In some examples, the mapping component 630 is capable of, configured to, or operable to support a means for mapping a second traffic flow associated with the connection to a second port number within a second port range of the set of multiple port ranges of the second network based on a second traffic classification assigned to the traffic flow.

In some examples, the second port range is associated with a second set of QoS characteristics different from the first set of QoS characteristics.

In some examples, the port reservation component 640 is capable of, configured to, or operable to support a means for reserving a set of multiple ports of the second network, where the traffic flow associated with the connection is mapped to the first port within the first port range based on the set of multiple ports being reserved.

In some examples, the port reservation component 640 is capable of, configured to, or operable to support a means for identifying the set of multiple port ranges based on the reserved set of multiple ports, where each port range of the set of multiple port ranges is associated with a respective subset of the reserved set of multiple ports.

In some examples, the port selection component 645 is capable of, configured to, or operable to support a means for selecting the first port from the first port range based on the first traffic classification assigned to the traffic flow, where the traffic flow is mapped to the first port based on selection of the first port.

In some examples, the first network includes a local area network, and the second network includes a cellular network.

In some examples, the first wireless communication device is one of a set of multiple wireless communication devices of an automotive system.

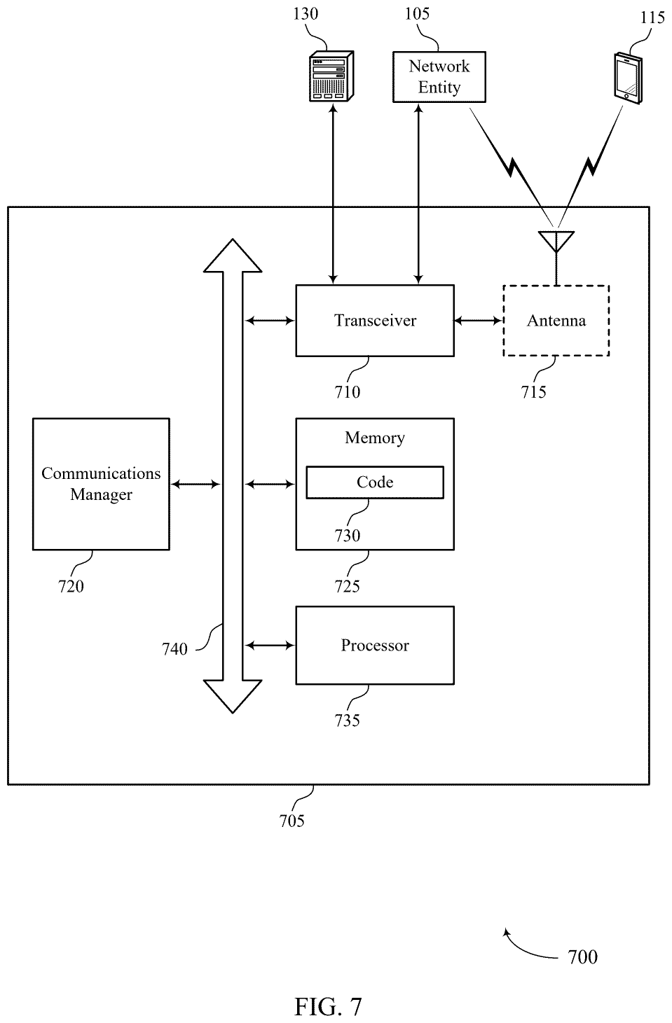

FIG. 7 shows a diagram of a system 700 including a device 705 that supports traffic classification to port mapping in accordance with one or more aspects of the present disclosure. The device 705 may be an example of or include components of a device 405, a device 505, or a customer premises equipment as described herein. The device 705 may include components for bi-directional voice and data communications including components for transmitting and receiving communications, such as a communications manager 720, a transceiver 710, one or more antennas 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting traffic classification to port mapping). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725).

In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with one or more other network entities 105, and may include a controller or scheduler for controlling communications with UEs 115 (e.g., in cooperation with the one or more other network devices). In some examples, the communications manager 720 may support an X2 interface within an LTE/LTE-A wireless communications network technology to provide communication between network entities 105.

The communications manager 720 may support wireless communications in accordance with examples as disclosed herein. For example, the communications manager 720 is capable of, configured to, or operable to support a means for communicating one or more messages to establish a connection between a first wireless communication device of a first network and a second network via the CPE. The communications manager 720 is capable of, configured to, or operable to support a means for mapping a traffic flow associated with the connection to a first port within a first port range of a set of multiple port ranges of the second network based on a first traffic classification of a set of multiple traffic classifications of the first network assigned to the traffic flow, where the first port range is associated with a first set of Quality of Service (QoS) characteristics of a set of multiple sets of QoS characteristics of the second network, and where each port range of the set of multiple port ranges is associated with a different set of QoS characteristics of the set of multiple sets of QoS characteristics. The communications manager 720 is capable of, configured to, or operable to support a means for communicating, via the CPE, data traffic of the traffic flow between the first wireless communication device and the second network via the first port in accordance with the first traffic classification and the first set of QoS characteristics.

By including or configuring the communications manager 720 in accordance with examples as described herein, the device 705 may support techniques for improved communication reliability, more efficient utilization of communication resources, and improved coordination between devices.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of traffic classification to port mapping as described herein, or the at least one processor 735 and the at least one memory 725 may be otherwise configured to, individually or collectively, perform or support such operations.

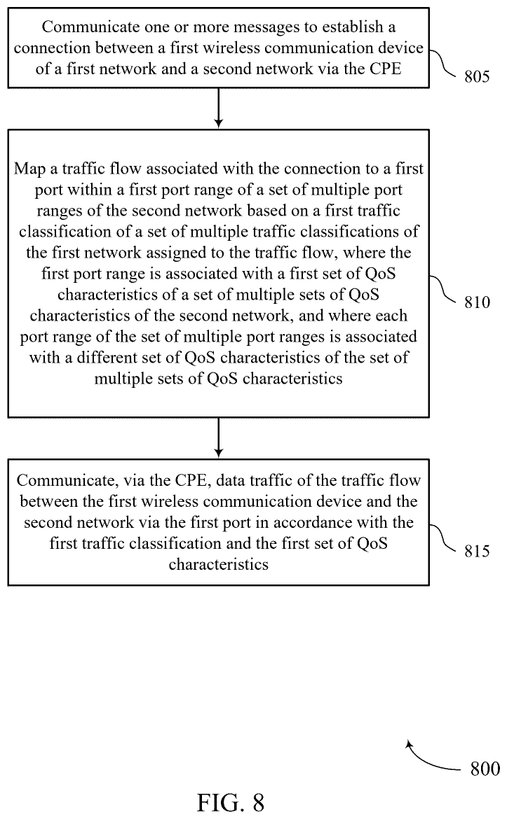

FIG. 8 shows a flowchart illustrating a method 800 that supports traffic classification to port mapping in accordance with one or more aspects of the present disclosure. The operations of the method 800 may be implemented by a customer premises equipment or its components as described herein. For example, the operations of the method 800 may be performed by a customer premises equipment as described with reference to FIGS. 1 through 7. In some examples, a customer premises equipment may execute a set of instructions to control the functional elements of the customer premises equipment to perform the described functions. Additionally, or alternatively, the customer premises equipment may perform aspects of the described functions using special-purpose hardware.

At 805, the method may include communicating one or more messages to establish a connection between a first wireless communication device of a first network and a second network via the CPE. The operations of 805 may be performed in accordance with examples as disclosed herein. In some examples, aspects of the operations of 805 may be performed by a connection component 625 as described with reference to FIG. 6.

At 810, the method may include mapping a traffic flow associated with the connection to a first port within a first port range of a set of multiple port ranges of the second network based on a first traffic classification of a set of multiple traffic classifications of the first network assigned to the traffic flow, where the first port range is associated with a first set of Quality of Service (QoS) characteristics of a set of multiple sets of QoS characteristics of the second network, and where each port range of the set of multiple port ranges is associated with a different set of QoS characteristics of the set of multiple sets of QoS characteristics. The operations of 810 may be performed in accordance with examples as disclosed herein. In some examples, aspects of the operations of 810 may be performed by a mapping component 630 as described with reference to FIG. 6.

At 815, the method may include communicating, via the CPE, data traffic of the traffic flow between the first wireless communication device and the second network via the first port in accordance with the first traffic classification and the first set of QoS characteristics. The operations of 815 may be performed in accordance with examples as disclosed herein. In some examples, aspects of the operations of 815 may be performed by a communication component 635 as described with reference to FIG. 6.

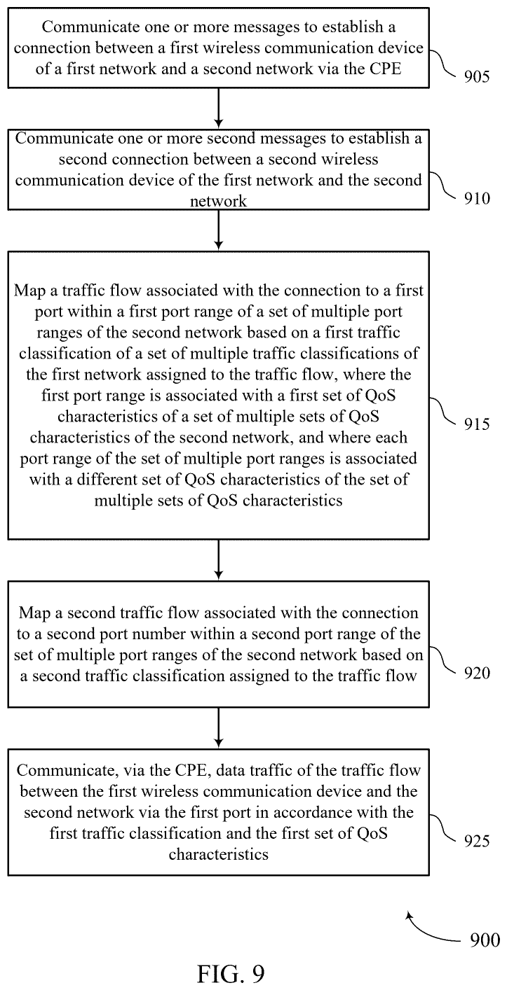

FIG. 9 shows a flowchart illustrating a method 900 that supports traffic classification to port mapping in accordance with one or more aspects of the present disclosure. The operations of the method 900 may be implemented by a customer premises equipment or its components as described herein. For example, the operations of the method 900 may be performed by a customer premises equipment as described with reference to FIGS. 1 through 7. In some examples, a customer premises equipment may execute a set of instructions to control the functional elements of the customer premises equipment to perform the described functions. Additionally, or alternatively, the customer premises equipment may perform aspects of the described functions using special-purpose hardware.

At 905, the method may include communicating one or more messages to establish a connection between a first wireless communication device of a first network and a second network via the CPE. The operations of 905 may be performed in accordance with examples as disclosed herein. In some examples, aspects of the operations of 905 may be performed by a connection component 625 as described with reference to FIG. 6.

At 910, the method may include communicating one or more second messages to establish a second connection between a second wireless communication device of the first network and the second network. The operations of 910 may be performed in accordance with examples as disclosed herein. In some examples, aspects of the operations of 910 may be performed by a connection component 625 as described with reference to FIG. 6.

At 915, the method may include mapping a traffic flow associated with the connection to a first port within a first port range of a set of multiple port ranges of the second network based on a first traffic classification of a set of multiple traffic classifications of the first network assigned to the traffic flow, where the first port range is associated with a first set of Quality of Service (QoS) characteristics of a set of multiple sets of QoS characteristics of the second network, and where each port range of the set of multiple port ranges is associated with a different set of QoS characteristics of the set of multiple sets of QoS characteristics. The operations of 915 may be performed in accordance with examples as disclosed herein. In some examples, aspects of the operations of 915 may be performed by a mapping component 630 as described with reference to FIG. 6.

At 920, the method may include mapping a second traffic flow associated with the connection to a second port number within a second port range of the set of multiple port ranges of the second network based on a second traffic classification assigned to the traffic flow. The operations of 920 may be performed in accordance with examples as disclosed herein. In some examples, aspects of the operations of 920 may be performed by a mapping component 630 as described with reference to FIG. 6.

At 925, the method may include communicating, via the CPE, data traffic of the traffic flow between the first wireless communication device and the second network via the first port in accordance with the first traffic classification and the first set of QoS characteristics. The operations of 925 may be performed in accordance with examples as disclosed herein. In some examples, aspects of the operations of 925 may be performed by a communication component 635 as described with reference to FIG. 6.

The following provides an overview of aspects of the present disclosure:

Aspect 1: A method for wireless communications at a CPE, comprising: communicating one or more messages to establish a connection between a first wireless communication device of a first network and a second network via the CPE; mapping a traffic flow associated with the connection to a first port within a first port range of a plurality of port ranges of the second network based at least in part on a first traffic classification of a plurality of traffic classifications of the first network assigned to the traffic flow, wherein the first port range is associated with a first set of QoS characteristics of a plurality of sets of QoS characteristics of the second network, and wherein each port range of the plurality of port ranges is associated with a different set of QoS characteristics of the plurality of sets of QoS characteristics; and communicating, via the CPE, data traffic of the traffic flow between the first wireless communication device and the second network via the first port in accordance with the first traffic classification and the first set of QoS characteristics.

Aspect 2: The method of aspect 1, further comprising: communicating one or more second messages to establish a second connection between a second wireless communication device of the first network and the second network; and mapping a second traffic flow associated with the connection to a second port number within a second port range of the plurality of port ranges of the second network based at least in part on a second traffic classification assigned to the traffic flow.

Aspect 3: The method of aspect 2, wherein the second port range is associated with a second set of QoS characteristics different from the first set of QoS characteristics.

Aspect 4: The method of any of aspects 1 through 3, further comprising: reserving a plurality of ports of the second network, wherein the traffic flow associated with the connection is mapped to the first port within the first port range based at least in part on the plurality of ports being reserved.

Aspect 5: The method of aspect 4, further comprising: identifying the plurality of port ranges based at least in part on the reserved plurality of ports, wherein each port range of the plurality of port ranges is associated with a respective subset of the reserved plurality of ports.

Aspect 6: The method of any of aspects 1 through 5, further comprising: selecting the first port from the first port range based at least in part on the first traffic classification assigned to the traffic flow, wherein the traffic flow is mapped to the first port based at least in part on selection of the first port.

Aspect 7: The method of any of aspects 1 through 6, wherein the first network comprises a local area network, and the second network comprises a cellular network.

Aspect 8: The method of any of aspects 1 through 7, wherein the first wireless communication device is one of a plurality of wireless communication devices of an automotive system.

Aspect 9: A CPE for wireless communications, comprising one or more memories storing processor-executable code, and one or more processors coupled with the one or more memories and individually or collectively operable to execute the code to cause the CPE to perform a method of any of aspects 1 through 8.

Aspect 10: A CPE for wireless communications, comprising at least one means for performing a method of any of aspects 1 through 8.

Aspect 11: A non-transitory computer-readable medium storing code for wireless communications, the code comprising instructions executable by one or more processors to perform a method of any of aspects 1 through 8.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A customer premises equipment (CPE), comprising:
one or more memories storing processor-executable code; and
one or more processors coupled with the one or more memories and individually or collectively operable to execute the code to cause the CPE to:
communicate one or more messages to establish a connection between a first wireless communication device of a first network and a second network via the CPE;
map a traffic flow associated with the connection to a first port within a first port range of a plurality of port ranges of the second network based at least in part on a first traffic classification of a plurality of traffic classifications of the first network assigned to the traffic flow, wherein the first port range is associated with a first set of Quality of Service (QoS) characteristics of a plurality of sets of QoS characteristics of the second network, and wherein each port range of the plurality of port ranges is associated with a different set of QoS characteristics of the plurality of sets of QoS characteristics; and
communicate, via the CPE, data traffic of the traffic flow between the first wireless communication device and the second network via the first port in accordance with the first traffic classification and the first set of QoS characteristics.

2. The CPE of claim 1, wherein the one or more processors are individually or collectively further operable to execute the code to cause the CPE to:
communicate one or more second messages to establish a second connection between a second wireless communication device of the first network and the second network; and
map a second traffic flow associated with the connection to a second port number within a second port range of the plurality of port ranges of the second network based at least in part on a second traffic classification assigned to the traffic flow.

3. The CPE of claim 2, wherein the second port range is associated with a second set of QoS characteristics different from the first set of QoS characteristics.

4. The CPE of claim 1, wherein the one or more processors are individually or collectively further operable to execute the code to cause the CPE to:
reserve a plurality of ports of the second network, wherein the traffic flow associated with the connection is mapped to the first port within the first port range based at least in part on the plurality of ports being reserved.

5. The CPE of claim 4, wherein the one or more processors are individually or collectively further operable to execute the code to cause the CPE to:
identify the plurality of port ranges based at least in part on the reserved plurality of ports, wherein each port range of the plurality of port ranges is associated with a respective subset of the reserved plurality of ports.

6. The CPE of claim 1, wherein the one or more processors are individually or collectively further operable to execute the code to cause the CPE to:
select the first port from the first port range based at least in part on the first traffic classification assigned to the traffic flow, wherein the traffic flow is mapped to the first port based at least in part on selection of the first port.

7. The CPE of claim 1, wherein:
the first network comprises a local area network, and
the second network comprises a cellular network.

8. The CPE of claim 1, wherein the first wireless communication device is one of a plurality of wireless communication devices of an automotive system.

9. A method for wireless communications at a customer premises equipment (CPE), comprising:
communicating one or more messages to establish a connection between a first wireless communication device of a first network and a second network via the CPE;
mapping a traffic flow associated with the connection to a first port within a first port range of a plurality of port ranges of the second network based at least in part on a first traffic classification of a plurality of traffic classifications of the first network assigned to the traffic flow, wherein the first port range is associated with a first set of Quality of Service (QoS) characteristics of a plurality of sets of QoS characteristics of the second network, and wherein each port range of the plurality of port ranges is associated with a different set of QoS characteristics of the plurality of sets of QoS characteristics; and
communicating, via the CPE, data traffic of the traffic flow between the first wireless communication device and the second network via the first port in accordance with the first traffic classification and the first set of QoS characteristics.

10. The method of claim 9, further comprising:
communicating one or more second messages to establish a second connection between a second wireless communication device of the first network and the second network; and
mapping a second traffic flow associated with the connection to a second port number within a second port range of the plurality of port ranges of the second network based at least in part on a second traffic classification assigned to the traffic flow.

11. The method of claim 10, wherein the second port range is associated with a second set of QoS characteristics different from the first set of QoS characteristics.

12. The method of claim 9, further comprising:
reserving a plurality of ports of the second network, wherein the traffic flow associated with the connection is mapped to the first port within the first port range based at least in part on the plurality of ports being reserved.

13. The method of claim 12, further comprising:
identifying the plurality of port ranges based at least in part on the reserved plurality of ports, wherein each port range of the plurality of port ranges is associated with a respective subset of the reserved plurality of ports.

14. The method of claim 9, further comprising:
selecting the first port from the first port range based at least in part on the first traffic classification assigned to the traffic flow, wherein the traffic flow is mapped to the first port based at least in part on selection of the first port.

15. The method of claim 9, wherein:
the first network comprises a local area network, and
the second network comprises a cellular network.

16. The method of claim 9, wherein the first wireless communication device is one of a plurality of wireless communication devices of an automotive system.

17. A non-transitory computer-readable medium storing code for wireless communications, the code comprising instructions executable by one or more processors to:
communicate one or more messages to establish a connection between a first wireless communication device of a first network and a second network via a customer premises equipment (CPE);
map a traffic flow associated with the connection to a first port within a first port range of a plurality of port ranges of the second network based at least in part on a first traffic classification of a plurality of traffic classifications of the first network assigned to the traffic flow, wherein the first port range is associated with a first set of Quality of Service (QoS) characteristics of a plurality of sets of QoS characteristics of the second network, and wherein each port range of the plurality of port ranges is associated with a different set of QoS characteristics of the plurality of sets of QoS characteristics; and
communicate, via the CPE, data traffic of the traffic flow between the first wireless communication device and the second network via the first port in accordance with the first traffic classification and the first set of QoS characteristics.

18. The non-transitory computer-readable medium of claim 17, wherein the instructions are further executable by the one or more processors to:
communicate one or more second messages to establish a second connection between a second wireless communication device of the first network and the second network; and
map a second traffic flow associated with the connection to a second port number within a second port range of the plurality of port ranges of the second network based at least in part on a second traffic classification assigned to the traffic flow.

19. The non-transitory computer-readable medium of claim 18, wherein the second port range is associated with a second set of QoS characteristics different from the first set of QoS characteristics.

20. The non-transitory computer-readable medium of claim 17, wherein the instructions are further executable by the one or more processors to:
reserve a plurality of ports of the second network, wherein the traffic flow associated with the connection is mapped to the first port within the first port range based at least in part on the plurality of ports being reserved.
